(19) United States
(12) Patent Application Publication
(10) Pub. No.: US 2016/0118861 A1
(43) Pub. Date: Apr. 28, 2016

(54) POWER GENERATION USING A PROTECTIVE CASE FOR A MOBILE DEVICE

(71) Applicants: Mark Joseph Gabriel, Baton Rouge, LA (US); Erik Alexis Durr, Dana Point, CA (US)

(72) Inventors: Mark Joseph Gabriel, Baton Rouge, LA (US); Erik Alexis Durr, Dana Point, CA (US)

(21) Appl. No.: 14/922,219

(22) Filed: Oct. 26, 2015

Related U.S. Application Data
(60) Provisional application No. 62/068,456, filed on Oct. 24, 2014.

(51) Int. Cl. H02K 7/18; H02J 7/00; H02K 7/116

(52) U.S. Cl. CPC H02K 7/1861; H02K 7/116; H02J 7/0044; H02J 7/0052

(57) ABSTRACT

A device for power generation using a protective case for a mobile device is disclosed. A power generating mobile device case includes a casing and an electric generator. The electric generator further includes a three-phase stator encompassed by a rotor can, a planetary gear train and a handle. The three-phase stator is stationary. The turning of the handle causes the planetary gear train to spin the rotor can around the three-phase stator, inducing an electric current in the three-phase stator. In addition, the rotor can includes a permanent magnet, and the power generating protective case is capable of coupling to the mobile device.

### CLAIM OF PRIORITY

This application is a Conversion/Non-Provisional Application of and claims priority to the U.S. Provisional Application No. 62/068,456 titled PROTECTIVE CASE FOR MOBILE DEVICE WITH POWER GENERATING DYNAMO, AUX USB POWER PORT(S), AND CABLE INCLUDED filed on Oct. 24, 2014.

### FIELD OF TECHNOLOGY

This disclosure relates generally to power generation and, more particularly, to a method and/or a device of power generation using a protective case for a mobile device.

### BACKGROUND

Mobile devices, such as smart phones, provide an increasing number of conveniences to modern life. However, as people become more reliant on mobile devices, a dead battery has become more disruptive. Backup batteries must be charged, and either represent a significant increase in the weight of the mobile device, or another device which must be carried. Furthermore, a backup battery has limited utility in situations where recharging may be difficult, such as in an emergency or natural disaster.

Previous hand powered electric generators may overcome the shortcomings of a backup battery, but may have their own deficiencies. These generators tend to be bulky, as well as noisy. Furthermore, linear gear trains may increase the dimensions of a generator beyond what is practical for a mobile solution, a problem that may compromise efficiency. A need exists for a thin, quiet, and efficient device for generating power for charging a mobile device.

### SUMMARY

Disclosed are a method and/or a device of power generation using a protective case for a mobile device.

In one aspect, a power generating mobile device case includes a casing and an electric generator. The electric generator further includes a three-phase stator encompassed by a rotor can, a planetary gear train and a handle. The three-phase stator is stationary. The turning of the handle causes the planetary gear train to spin the rotor can around the three-phase stator, inducing an electric current in the three-phase stator. In addition, the rotor can includes at least one permanent magnet, and the power generating mobile device case is capable of coupling to a mobile device.

The planetary gear train may include a carrier, at least one planetary gear and/or a sun gear. The carrier may be affixed to the handle, and the sun gear may be affixed to the rotor can. The handle, the sun gear, and/or the carrier may all rotate about a single axis. The at least one planetary gear may be coupled to the carrier and may be engaged with the sun gear, such that the carrier turns with the handle, causing the at least one planetary gear to orbit the sun gear, and the sun gear and/or the rotor can to spin. The planetary gear train may be encompassed by the three-phase stator and/or the rotor can.

The three-phase stator may include at least one laminated core with at least four laminated layers. The power generating mobile device may include a charging cable, a mobile device case connector on a first end of the charging cable, a device connector on a second end of the charging cable, and/or a charging port electrically coupled to the electric generator. The charging cable may be capable of being attached, detached and/or reattached to the power generating mobile device case. The mobile device and/or another device may be charged using the charging cable connected to the mobile device and/or another device using the device connector and/or connected to the power generating mobile device case using the mobile device case connector.

The power generating mobile device may include at least one battery. The at least one battery may be electrically coupled to the charging port and/or the electric generator. The handle may be configured to operate as a stand for the coupled mobile device.

The power generating mobile device may include a pulley and/or a belt. The planetary gear train may be attached to the pulley. The three-phase stator encompassed by the rotor can may be coupled to the planetary gear train attached to the pulley by the belt. The planetary gear train and the three-phase stator may be located on the same plane. The belt may be a drive belt and/or a timing belt. The belt may be made of polyurethane, neoprene, and/or nitrile rubber. The belt may have a diameter of at least 1/16 of an inch. The casing may include one or more plates. The casing may include a faceplate and/or a backplate.

In another aspect, a power generating mobile device case includes a casing and a synchronous electric generator. The synchronous electric generator further includes a three-phase stator encompassed by a rotor can, a planetary gear train, a pulley, a belt, and a handle. The three-phase stator is stationary and the handle is capable of being stored flush with the backplate when not in use. The turning of the handle causes the planetary gear train to spin the rotor can around the three-phase stator, inducing an electric current in the three-phase stator. In addition, the rotor can includes an assembly of permanent magnets and the power generating mobile device case is capable of coupling to a mobile device. The planetary gear train is attached to the pulley. The three-phase stator encompassed by the rotor can is coupled to the planetary gear train attached to the pulley by the belt. The planetary gear train and the three-phase stator are located on the same plane.

In yet another aspect, a power generating mobile device case includes a casing and an electric multiphase generator. The electric multiphase generator further includes a three-phase stator encompassed by a rotor can, a planetary gear train and a handle. The three-phase stator is stationary. The turning of the handle causes the planetary gear train to spin the rotor can around the three-phase stator, inducing an electric current in the three-phase stator. The rotor can includes at least one permanent magnet, and the power generating mobile device case is capable of coupling to a mobile device. In addition, the planetary gear train includes a carrier, at least one planetary gear, and a sun gear. The carrier is affixed to the handle. The at least one planetary gear is coupled to the carrier and is engaged with the sun gear, such that the carrier turns with the handle, causing the at least one planetary gear to orbit the sun gear, causing the sun gear and the rotor can to spin.

The methods and devices disclosed herein may be implemented in any means for achieving the various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 shows an exploded view 150 and a side view 160 of a power generating mobile device case 100 comprising an electric generator 108, according to one embodiment.

FIG. 2 shows an exploded side view 260 and a top view 250 of the electric generator 108 of the power generating mobile device case 100 of FIG. 1, comprising a planetary gear train 200 and a three-phase stator assembly 207, according to one embodiment.

FIG. 3 shows a top view 350 and an exploded side view 360 of the planetary gear train 200 of the power generating mobile device case 100 of FIG. 1, according to one embodiment.

FIG. 4 shows a schematic view 450 of the power generating mobile device case 100 of FIG. 1, according to one embodiment.

FIG. 5 is a preferred embodiment view 550 of a power generating mobile device case 500 having a charging cable 406 that is physically independent of the power generating mobile device case 500, according to one embodiment.

FIG. 6 is an interior view 650 of the power generating mobile device case 500 of FIG. 5 in a flat interior configuration, and in which the three-phase stator assembly 207 is mechanically coupled with the planetary gear train 200 (not shown) of FIG. 2 through a pulley 602 and a belt 604 to reduce a physical thickness required for the power generating mobile device case 500 and to increase efficiency of electricity generation when the handle 110 (not shown) is rotated, according to one embodiment.

FIG. 7 is a gear train view 740 of the belt 604 of FIG. 6 coupled with the planetary gear train 200 of FIG. 2 through the pulley 602 (not shown) of FIG. 6, according to one embodiment.

FIG. 8 is a folded view 850 of the power generating mobile device case 500 of FIG. 5, illustrating a folded state of a handle 800 (e.g., similar to the handle 110 of FIG. 1) to reduce thickness, according to one embodiment.

FIG. 9 is an extended view 950 of the power generating mobile device case 500 of FIG. 5, illustrating an extended state of a handle 900 (e.g., similar to the handle 110 of FIG. 1) to provide electricity generation when the extended handle 900 is rotated, or, alternatively, to serve as a stand (e.g., similar to the stand 116 of FIG. 1) for the mobile device 106 of FIG. 1 when in extended form, according to one embodiment.

FIG. 10 is a cross-section view 1050 of the power generating mobile device case 500 of FIG. 5.

Other features of the present embodiments will be apparent from the accompanying drawings and from the detailed description that follows.

### DETAILED DESCRIPTION

Example embodiments, as described below, may be used to provide a method, and/or a device of power generation using a protective case for a mobile device.

In one embodiment, a power generating mobile device case 100 includes a casing 101 and an electric generator 108. The electric generator 108 further includes a three-phase stator 202 encompassed by a rotor can 204, a planetary gear train 200 and a handle 110. The three-phase stator 202 is stationary. The turning of the handle 110 causes the planetary gear train 200 to spin the rotor can 204 around the three-phase stator 202, inducing an electric current 400 in the three-phase stator 202. In addition, the rotor can 204 includes at least one permanent magnet 206 and the power generating mobile device case 100 is capable of coupling to a mobile device 106.

The planetary gear train 200 may include a carrier 304, at least one planetary gear 300 and/or a sun gear 302. The carrier 304 may be affixed to the handle 110 and the sun gear 302 may be affixed to the rotor can 204. The handle 110, the sun gear 302, and/or the carrier 304 may all rotate about a single axis 208. The at least one planetary gear 300 may be coupled to the carrier 304 and may be engaged with the sun gear 302, such that the carrier 304 turns with the handle 110, causing the at least one planetary gear 300 to orbit the sun gear 302, causing the sun gear 302 and/or the rotor can 204 to spin. The planetary gear train 200 may be encompassed by the three-phase stator 202 and/or the rotor can 204. The three-phase stator 202 may include at least one laminated core 210 with at least 4 laminated layers 212.

The power generating mobile device case 100 may include a charging cable 406, a mobile device case connector (e.g., a connector to case 505) on a first end of the charging cable 507, a device connector (e.g., a connector to phone 503) on a second end of the charging cable 509, and a charging port 112 electrically coupled to the electric generator 108. The charging cable 406 may be capable of being attached, detached and/or reattached to the power generating mobile device case 100. The mobile device 106 and/or another device may be charged using the charging cable 406 connected to the mobile device 106 and/or another device using the device connector (e.g., a connector to phone 503) and connected to the power generating mobile device case 100 using the mobile device case connector (e.g., the connector to case 505).

The power generating mobile device case 100 may include at least one battery 404. The at least one battery 404 may be electrically coupled to the charging port 112 and/or the electric generator 108. The handle 110 may be configured to operate as a stand 116 for the coupled mobile device 106.

The power generating mobile device case 101 may include a pulley 602 and/or a belt 604. The planetary gear train 200 may be attached to the pulley 602. The three-phase stator 202 encompassed by the rotor can 204 may be coupled to the planetary gear train 200 attached to the pulley 602 by the belt 604. The planetary gear train 200 and the three-phase stator 202 may be located on the same plane. The belt 604 may be a drive belt and/or a timing belt. The belt 604 may be made of polyurethane, neoprene, and/or nitrile rubber. The belt 604 may have a diameter of at least 1/16 of an inch. The casing 101 may include one or more plates. The casing may include a faceplate 102 and/or a backplate 104.

In another embodiment, a power generating mobile device case 100 includes a casing 101 and a synchronous electric generator 108. The synchronous electric generator 108 further includes a three-phase stator 202 encompassed by a rotor can 204, a planetary gear train 200, a pulley 602, a belt 604, and a handle 110. The three-phase stator 202 is stationary and the handle 110 is capable of being stored flush with the casing 101 when not in use. Turning the handle 110 causes the planetary gear train 200 to spin the rotor can 204 around the three-phase stator 202, inducing an electric current 400 in the three-phase stator 202. In addition, the rotor can 204 includes an assembly of permanent magnets 206 and the power generating mobile device case 100 is capable of coupling to a mobile device 106. The planetary gear train 200 is attached to the pulley 602 and the three-phase stator 202 encompassed by the rotor can 204 is coupled to the planetary gear train 200 attached to the pulley 602 by the belt 604. The planetary gear train 200 and the three-phase stator 202 are located on the same plane.

In yet another embodiment, a power generating mobile device case 100 includes a casing 101 and an electric multiphase generator 108. The electric multiphase generator 108 further includes a three-phase stator 202 encompassed by a rotor can 204, a planetary gear train 200, and a handle 110. The three-phase stator 202 is stationary. Turning the handle 110 causes the planetary gear train 200 to spin the rotor can 204 around the three-phase stator 202, inducing an electric current 400 in the three-phase stator 202. The rotor can 204 includes at least one permanent magnet 206. The power generating mobile device case 100 is capable of coupling to a mobile device 106. In addition, the planetary gear train 200 includes a carrier 304, at least one planetary gear 300 and a sun gear 302. The carrier 304 is affixed to the handle 110 and the at least one planetary gear 300 is coupled to the carrier 304 and is engaged with the sun gear 302, such that the carrier 304 turns with the handle 110, causing the at least one planetary gear 300 to orbit the sun gear 302, causing the sun gear 302 and rotor can 204 to spin.

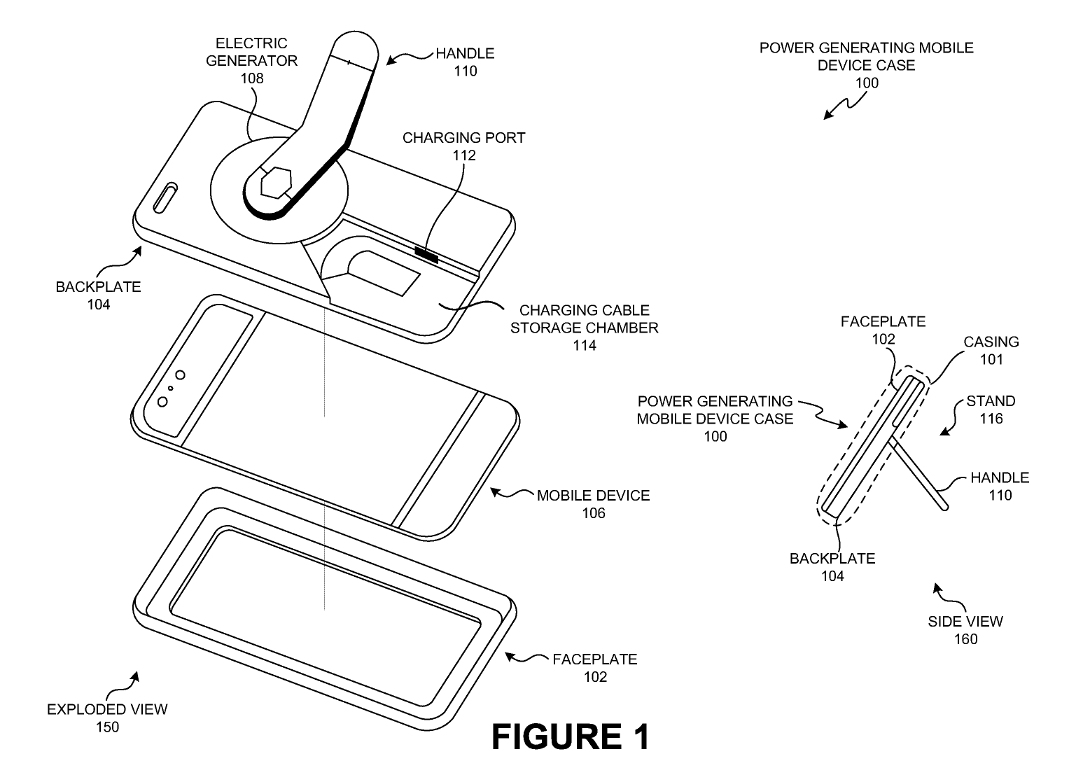

FIG. 1 shows an exploded view 150 and a side view 160 of a power generating mobile device case 100 comprising an electric generator 108, according to one embodiment. Specifically, FIG. 1 shows a power generating mobile device case 100, a casing 101, a faceplate 102, a backplate 104, a mobile device 106, an electric generator 108, a handle 110, a charging port 112, a charging cable storage chamber 114, and a stand 116.

The power generating mobile device case 100 may be a container designed to couple to the mobile device 106. The power generating mobile device case 100 may enclose, at least partially, the mobile device 106, and is capable of producing electricity to power the mobile device 106 and/or other devices. In some embodiments, the power generating mobile device case 100 may comprise materials which provide rigid structure needed for the power generating activities. These materials may include, but are not limited to, thermoplastic and/or other hard polymers. In other embodiments, the power generating mobile device case 100 may also comprise materials selected for their ability to absorb impacts (e.g. falls, etc.) or provide protection from liquids. These materials may include, but are not limited to, silicone and/or rubber.

The casing 101 may be an outer covering and/or shell that protects, surrounds, and/or encloses the mobile device 106 and may include one or more plates (e.g., the faceplate 102 and/or the backplate 104). The casing 101 and/or the plates may include one or more panels and/or one or more walls that cover, protect, surround, and/or enclose the mobile device 106. In some embodiments, the casing 101 may comprise materials which provide rigid structure needed for the power generating activities. These materials may include, but are not limited to, thermoplastic and/or other hard polymers. In other embodiments, the casing 101 may also comprise materials selected for their ability to absorb impacts (e.g. falls, etc.) or provide protection from liquids. These materials may include, but are not limited to, silicone and/or rubber.

The faceplate 102 may be a portion of the casing 101 of the power generating mobile device case 100 which covers the face of the mobile device 106 being coupled to and/or enclosed by the power generating mobile device case 100. In some embodiments, the casing 101 may have an opening through which a touchscreen of the mobile device 106 may be operated. In other embodiments, the casing 101 and/or the faceplate 102 may include a transparent material to protect the touchscreen of the mobile device 106, while still permitting its operation (i.e. the transparent material does not prevent the detection of a user's touches). According to various embodiments, the faceplate 102 may cover the entire face of the mobile device 106. In other embodiments, the faceplate 102 may only cover a portion of the face of the mobile device 106 (e.g., the rim and/or one or more edges of the mobile device 106).

The backplate 104 may be a portion of the casing 101 of the power generating mobile device case 100 which covers the back of the mobile device 106. According to various embodiments, the backplate 104 may cover the entire back of the mobile device 106. In other embodiments, the backplate 104 may only cover a portion of the back of the mobile device 106. In various embodiments, the faceplate 102 and the backplate 104 may lock together, securing the mobile device 106 within. The mobile device 106 may be a portable electronic device. Examples include, but are not limited to, smartphones, tablets, e-books, netbooks, and laptops.

The electric generator 108 may be a device which converts mechanical energy into electrical energy. In some embodiments, the electric generator 108 may produce electrical energy through induction, by exposing a conductive circuit to a changing magnetic field. This electrical energy may be in the form of an alternating current, according to one embodiment.

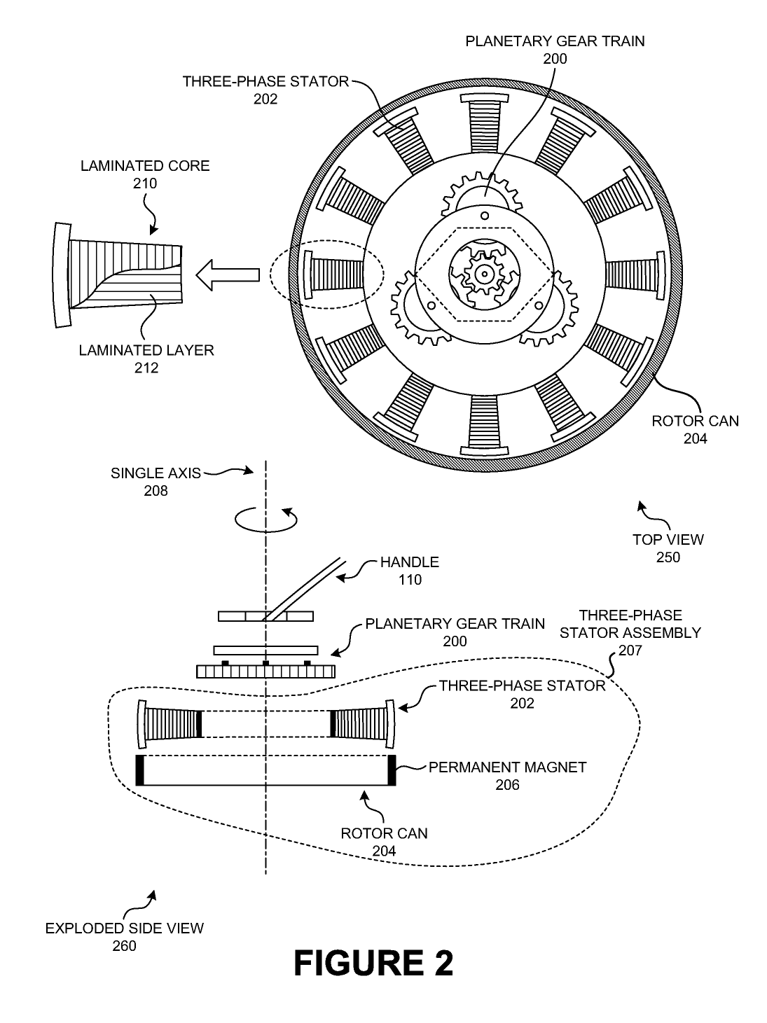

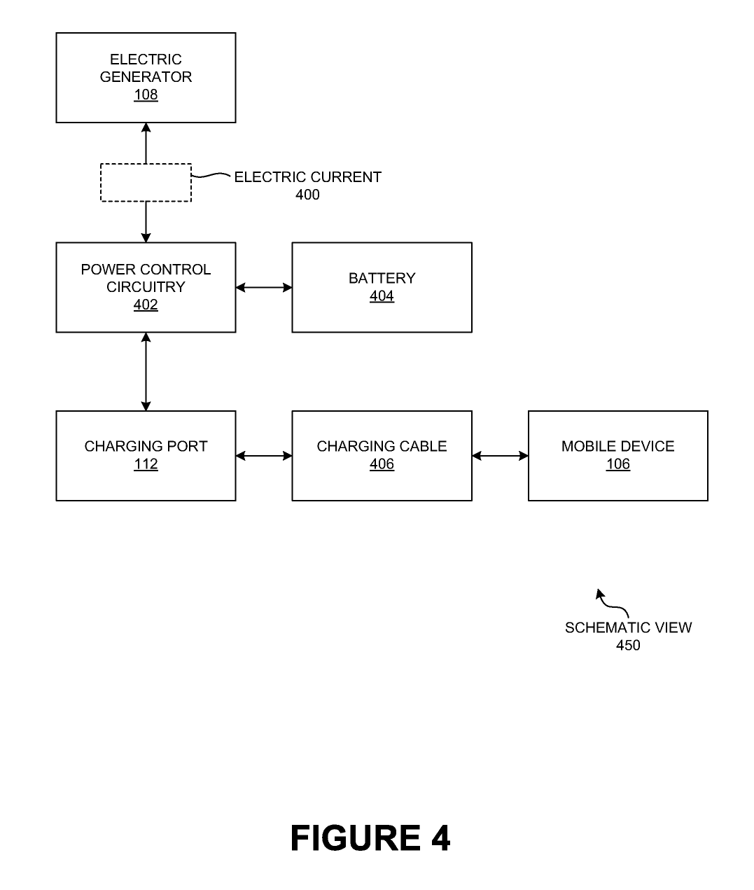

In various embodiments, the electric generator 108 of FIG. 1 may also be described as a synchronous electric generator 108, since the rotor (e.g. the rotor can 204 of FIG. 2, etc.) and the magnetic field may rotate with the same speed. In various embodiments, the electric generator 108 of FIG. 1 may also be described as an electric multiphase generator, as it may employ a multiphase stator (e.g. the three-phase stator 202 of FIG. 2, etc.) where an electrical current (e.g. the electrical current 400 of FIG. 4, etc.) may be induced by a magnetic field.

The handle 110 may be a part of the casing 101 (e.g., part of the backplate 104) through which mechanical energy is delivered to the electric generator 108 (e.g., when the handle 110 is turned, etc.). The handle 110 may fold into the casing 101 (e.g., into the backplate 104) when not in use, according to one embodiment. As an option, the handle 110 may fit flush with the casing 101 (e.g., with the backplate 104) when stowed. The end of the handle 110 may comprise a portion which may freely rotate, allowing a user to turn the handle 110 without having to readjust their grip to make a complete rotation.

The charging port 112 may be a port which is used to couple the power generating mobile device case 100 to the mobile device 106, another device and/or an external resource. The charging port 112 may simplify the process of docking and/or charging the mobile device 106 through a single connector and may be capable of receiving a charging cable 406. According to one embodiment, the charging port 112 may be a USB port which conforms to the Universal Serial Bus standard, and may be capable of receiving a standard USB cable. According to various other embodiments, the charging port 112 may be a Lightning® connector port, a micro-USB port, and/or other standard and/or custom charging port. The charging port 112 may be coupled to the electric generator 108 of the power generating mobile device case 100. The charging cable storage chamber 114 may be a cavity within the casing 101 (e.g., within the backplate 104) of the power generating mobile device case 100 which may be used to store a charging cable 406 compatible with the mobile device 106 (e.g., a small USB cable).

The stand 116 may be a configuration of the handle 110, in which the handle 110 is used to prop up the coupled and/or enclosed mobile device 106 at a desirable angle, when placed on a surface. In one embodiment, the handle 110 may be positioned and/or locked into one of multiple positions, providing multiple angles for different device orientations.

As shown, the faceplate 102 and the backplate 104 may fit together to enclose the mobile device 106, according to various embodiments. In one embodiment, the faceplate 102 and the backplate 104 may snap together and/or apart without the need for tools. In another embodiment, the faceplate 102 and the backplate 104 may be secured together with fasteners (e.g. bolts, screws, etc.).

FIG. 1 shows that the casing 101 (e.g., the backplate 104) may also comprise a charging cable storage chamber 114, according to various embodiments. According to one embodiment, the charging cable storage chamber 114 may be opened by deploying the handle 110 (e.g. snapping it out of the backplate 104 so that it may be turned, etc.). The charging cable storage chamber 114 may store the charging cable 406 configured to attach to the mobile device 106 (e.g., a small USB cable), and may also include the charging port 112, which provides the electricity produced by the electric generator 108 when the handle 110 is turned.

FIG. 1 also shows the handle 110 being attached to the casing 101 (e.g., attached to the backplate 104) at a point which is both a hub which rotates to operate the electric generator 108, and is hinged, allowing the handle 110 to be pulled away from the casing 101 (e.g., away from the backplate 104). As an option, the hub may be non-circular (e.g. hexagonal, etc.) to better endure the stress of turning the electric generator 108.

The power generating mobile device case 100 may be used to charge a device, either the mobile device 106 coupled to and/or enclosed within the power generating mobile device case 100, or another device which may be powered by DC current provided by the charging cable 406. This may be advantageous in situations where normal power sources are not available, either due to location (e.g. camping, traveling, etc.) or circumstance (e.g. emergencies, natural disasters, blackouts, etc.).

FIG. 2 shows a top view 250 and an exploded side view 260 of the electric generator 108 of the power generating mobile device case 100 of FIG. 1, comprising a planetary gear train 200, according to one embodiment. Specifically, FIG. 2 shows a planetary gear train 200, a three-phase stator 202, a rotor can 204, a permanent magnet 206, a three-phase stator assembly 207, a single axis 208, a laminated core 210, and a laminated layer 212, in addition to the handle 110 of FIG. 1.

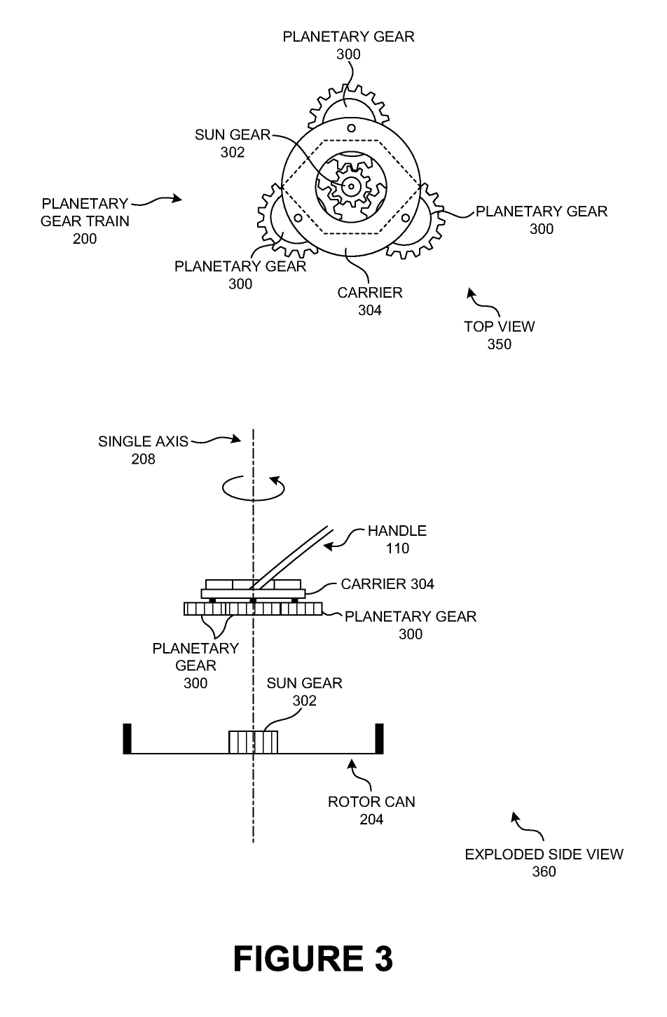

The planetary gear train 200 may be a system of gears which transmit rotational motion from one side to another. Specifically, the planetary gear train 200 may consist of at least one planetary gear 300 (e.g. the planetary gear 300 of FIG. 3, etc.) which is engaged with, and orbits around, a central sun gear 302 (e.g. the sun gear 302 of FIG. 3, etc.). A carrier 304 connects the centers of the planetary gear(s) 300 and the sun gear 302, and rotates as the planetary gear(s) 300 orbit the sun gear 302.

As shown in FIG. 2, the planetary gear train 200 may be a simple planetary gear train 200; in other embodiments, the planetary gear train 200 may be a compound gear train. In some embodiments, there may also be an outer gear ring (not pictured), which is also engaged with the at least one planetary gear 300. The at least one planetary gear 300 may be coupled to a carrier 304. The planetary gear train 200 may also be referred to as an epicyclic train. In various embodiments, the planetary gear train 200 may include three planetary gears 300.

The three-phase stator 202 may be a stationary part of the electric generator 108 of FIG. 1, which also serves as the power-producing component, as it comprises at least one armature within which electric current 400 is induced by the magnetic field of the rotor (e.g. the rotor can 204, etc.). Furthermore, the three-phase stator 202 may comprise three separate sets of conductive windings which may carry an alternating current of the same frequency, but whose phases are separated by 120 degrees.

The rotor can 204 may be a rotating part of the electric generator 108 of FIG. 1, which also serves as the magnetic field generation component. The rotor can 204 may comprise one or more permanent magnets 206, according to one embodiment. The rotor can 204 may be described as a cylinder where one or both ends are at least partially open. As a specific example, the rotor can 204 of FIG. 2 has one end open, and the other end intact. In other embodiments, the rotor can 204 may comprise an open end and a partially intact end; for example, the partially intact end may include a plurality of flattened “spokes” connecting the cylindrical surface with a central axis about with the rotor can 204 spins. In one embodiment, the rotor can 204 may also incorporate the sun gear 302 (e.g. the sun gear 302 of FIG. 3, etc.) of the planetary gear train 200; in other embodiments, the sun gear 302 may simply be affixed to the rotor can 204.

The permanent magnet 206 may be a magnet that creates its own persistent magnetic field, even in the absence of an inducing field or current. One or more permanent magnets 206 (e.g. an assembly of permanent magnets 206, etc.) may be coupled to the rotor can 204 to provide a magnetic field for power generation. In various embodiments, the permanent magnet 206 may be a rare-earth magnet. Examples include, but are not limited to, samarium-cobalt and neodymium-iron-boron. The three-phase stator assembly 207 may be a grouping of machine parts (e.g., the three-phase stator 202, the rotor can 204, and/or the permanent magnet 206).

The single axis 208 may be an axis about which multiple components of the electric generator 108 rotate. The laminated core 210 may be a piece of metallic material, encased in insulating material, around which the armature winding is wrapped. The laminated core 210 may be made up of one or more laminated layers 212.

As shown in FIG. 2, the planetary gear train 200 is coupled to the rotor can 204, such that operation of the planetary gear train 200 will cause the rotor can 204 to spin while the three-phase stator 202 remains stationary. The planetary gear train 200 is operated by turning the handle 110, which is coupled to the planetary gear train 200. The handle 110, the rotor can 204, and aspects of the planetary gear train 200 all rotate about a single axis 208, according to one embodiment.

The utility of the power generating mobile device case 100 depends upon a number of factors. It needs to generate electricity efficiently, yet not be so cumbersome as to make the mobile device 106 unwieldy. According to one embodiment, the thickness of the electric generator 108, and the power generating mobile device case 100 overall, may be reduced by reducing the thickness and number of laminated layers 212 within the wire-wrapped laminated cores 210 of the three-phase stator 202. In one embodiment, each laminated core 210 may comprise four laminated layers 212.

FIG. 3 shows a top view 350 and an exploded side view 360 of the planetary gear train 200 of the power generating mobile device case 100 of FIG. 1, according to one embodiment. Specifically, FIG. 3 shows a planetary gear 300, a sun gear 302, and a carrier 304, in addition to the planetary gear train 200, the rotor can 204, and the single axis 208 of FIG. 2, as well as the handle 110 of FIG. 1.

The planetary gear 300 may be a gear which is engaged with, and orbits around, the sun gear 302 of the planetary gear train 200. The sun gear 302 may be a gear which is engaged with a set of one or more planetary gears 300, and rotates about the axis on which the set of planetary gears 300 is centered.

The carrier 304 may be an object which connects the one or more planetary gears 300, and which is centered on the sun gear 302 of the planetary gear train 200. The planetary gear(s) 300 may freely spin on an axis where they are attached to the carrier 304. The carrier 304 may rotate about the same axis on which the sun gear 302 spins.

In various embodiments, the planetary gear train 200 may provide a gear ratio of 7 to 1. This means that for every turn of the handle 110, the rotor can 204 spins seven times. Higher gear ratios are possible, but may be associated with an increased loss of energy due to the friction of the gear teeth. According to one embodiment, the gear ratio of the planetary gear train 200 of FIG. 3 may be calculated as twice the sum of the number of planetary (Np) and sun (Ns) teeth, divided by the number of sun teeth (i.e. 2(Np+Ns)/Ns). A gear ratio of 7 to 1 could require 2.5 times more teeth on a planetary gear 300 as there are on the sun gear 302.

As shown in FIG. 3, the handle 110 is coupled to the carrier 304 of the planetary gear train 200, while the sun gear 302 is affixed to the rotor can 204, according to one embodiment. Turning the handle 110 causes the carrier 304 to rotate about the single axis 208, which in turn cause each of the planetary gears 300 to rotate about the axis by which it is coupled to the carrier 304. The rotating of the planetary gears 300 cause the rotation of the sun gear 302 with which they are engaged, resulting in the spinning of the rotor can 204.

According to one embodiment, the planetary gear train 200 is located inside the rotor can 204, allowing for a larger diameter of the rotor can 204 (e.g. the magnetic rotor of the electric generator 108, etc.). The expanded diameter of the rotor permits the use of a lower gear ratio while still generating electricity at a realistic handle 110 speed (e.g. 45 rotations per minute). The lower gear ratio, in turn, may mean less noise during operation, and less energy lost to gear friction.

FIG. 4 shows a schematic view 450 of the power generating mobile device case 100 of FIG. 1, according to one embodiment. Specifically, FIG. 4 shows an electric current 400, a power control circuitry 402, a battery 404, and a charging cable 406, in addition to the electric generator 108, the mobile device 106, and the charging port 112 of FIG. 1.

An electric current 400 may be a flow of electricity through a conductor. In various embodiments, the electric current 400 produced by the electric generator 108 is an alternating current.

The power control circuitry 402 may be electronic circuitry which regulates the voltage of the electricity being supplied to the mobile device 106 through the charging port 112. Since the mechanical energy being supplied to the electric generator 108 is provided by a human, the speed at which the handle 110 is turned may vary to a large degree; the power control circuitry 402 ensures that the electricity being delivered to the charging port 112 conforms to operating parameters associated with industry standards. For example, according to one embodiment, the charging port 112 may conform to the operating parameters associated with the Universal Serial Bus standard. According to various embodiments, the power control circuitry 402 regulates the voltage by not providing electricity to the charging port 112 until a particular voltage threshold is being met, and by dumping excess electricity when a maximum voltage is being exceeded. The power control circuitry 402 may also include an AC-DC converter circuit.

The battery 404 may be an electric energy storage device. In one embodiment, the power generating mobile device case 100 may include at least one battery 404 which may be charged using the electric generator 108 and/or by connecting to another power source.

The charging cable 406 may be a cable that communicates, transmits and/or supplies power from the power generating mobile device case 100 to the mobile device 106 and/or another device. According to a particular embodiment, the charging cable 406 may be a USB cable which conforms to the Universal Serial Bus standard. According to various other embodiments, the charging cable 406 may also conform to the standards of a particular type of mobile device 106 (e.g. a Lightning® cable, a micro-USB cable, and/or other standard and/or custom mobile device cable). As shown in FIG. 4, the electric generator 108 is coupled with, and provides electric current 400 to, the power control circuitry 402, which is in turn coupled to the charging port 112. A consequence of using a permanent magnet synchronous generator in a hand-cranked solution is that the resulting electric current 400 may have an unstable voltage. In various embodiments, the power control circuitry 402 may ensure that the power provided to the charging port 112 is within a voltage range suitable for powering and/or charging a device (e.g., the mobile device 106).

As an option, the power generating mobile device case 100 may comprise at least one battery 404. The power control circuitry 402 may dump excess electricity generated into the battery(ies) 404, according to one embodiment. The energy stored in the battery(ies) 404 may be provided through the charging port 112. In another embodiment, the user may charge the battery(ies) 404 using the electric generator 108, or they may charge it through the charging cable 406. In some embodiments, the power generating mobile device case 100 may include a charge indicator (e.g. LED lights, etc.) showing the charge status of the battery(ies) 404. However, other embodiments may not include a battery(ies) 404.

As shown, the mobile device 106 may be electrically coupled to the power generating mobile device case 100 through the charging cable 406 attached to the charging port 112 located in the casing 101 (e.g., in the backplate 104). Storing the charging cable 406 inside the charging cable storage chamber 114 allows for charging anywhere, and may be convenient for connecting the mobile device 106 to a computer system.

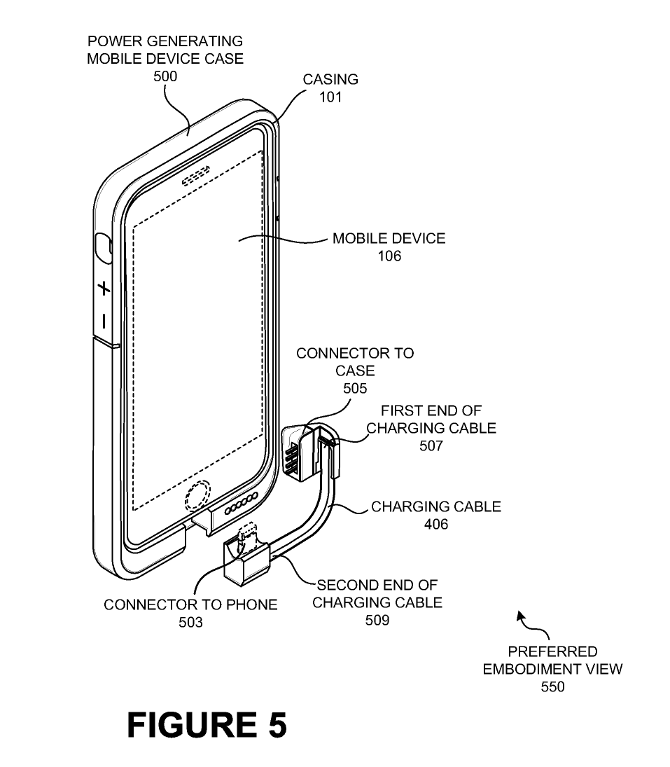

FIG. 5 shows a preferred embodiment view 550 of a power generating mobile device case 500 having a charging cable 406 that is physically independent of the power generating mobile device case 500, according to one embodiment. Specifically, FIG. 5 shows a power generating mobile device case 500, a connector to phone 503, a connector to case 505, a first end of charging cable 507, and a second end of charging cable 509.

The power generating mobile device case 500 may be used to charge a device, either the mobile device 106 coupled to and/or enclosed within the power generating mobile device case 500, or another device. This may be advantageous in situations where normal power sources are not available, either due to location (e.g. camping, traveling, etc.) or circumstance (e.g. emergencies, natural disasters, blackouts, etc.). The power generating mobile device case 500 may be similar to the power generating mobile device case 100 of FIG. 1.

The charging cable 406 may have a first end (e.g., the first end of charging cable 507) and/or a second end (e.g., the second end of charging cable 509). The charging cable 406 may include a mobile device case connector (e.g., the connector to case 505) on one end of the charging cable 406 (e.g., on the first end of charging cable 507) and/or a device connector (e.g., the connector to phone 503) on another end of the charging cable 406 (e.g., on the second end of charging cable 509). The mobile device case connector (e.g., the connector to case 505) may be used to connect the charging cable 406 to the power generating mobile device case 500. The device connector (e.g., the connector to phone 503) may be used to connect the charging cable 406 to the mobile device 106 and/or another device. The mobile device case connector (e.g., the connector to case 505) and/or the device connector (e.g., the connector to phone 503) may be a Lightning® connector, a micro-USB, a USB, and/or other standard and/or custom mobile device connector.

As an option, the power generating mobile device case 500 may comprise at least one battery 404. The power control circuitry 402 may dump excess electricity generated into the battery(ies) 404, according to one embodiment. The energy stored in the battery(ies) 404 may be provided through the charging port 112. In another embodiment, the user may charge the battery(ies) 404 using the electric generator 108, or they may charge it through the charging cable 406. In some embodiments, the power generating mobile device case 500 may include a charge indicator (e.g. LED lights, etc.) showing the charge status of the battery(ies) 404. However, other embodiments may not include a battery(ies) 404.

In various embodiments, the charging cable 406 may be physically independent of the power generating mobile device case 500, capable of being attached, detached, and/or reattached to the power generating mobile device case 500. The modularity of the charging cable 406 may allow for cost-savings in the manufacturing of the power generating mobile device case 500. The charging cable 406 may require a license in order to manufacture the device connector (e.g., the connector to phone 503) to be compatible with the mobile device 500 and/or another device. By having the charging cable 406 be physically independent of the power generating mobile device case 500, the charging cable 406 may be manufactured separately from the remainder of the power generating mobile device case 500, according to one embodiment. Therefore, licensing fees may only have to be paid to manufacture the charging cable 406 rather than for each power generating mobile device case 500 and/or variation of the power generating mobile device case 500. Further, if the charging cable 406 were to break or malfunction, this piece could be replaced without requiring a replacement of the entire power generating mobile device case 500. In various other embodiments, the charging cable 406 may be used with other types of mobile phone cases (e.g., a battery pack charging case, a solar powered charging case, etc.)

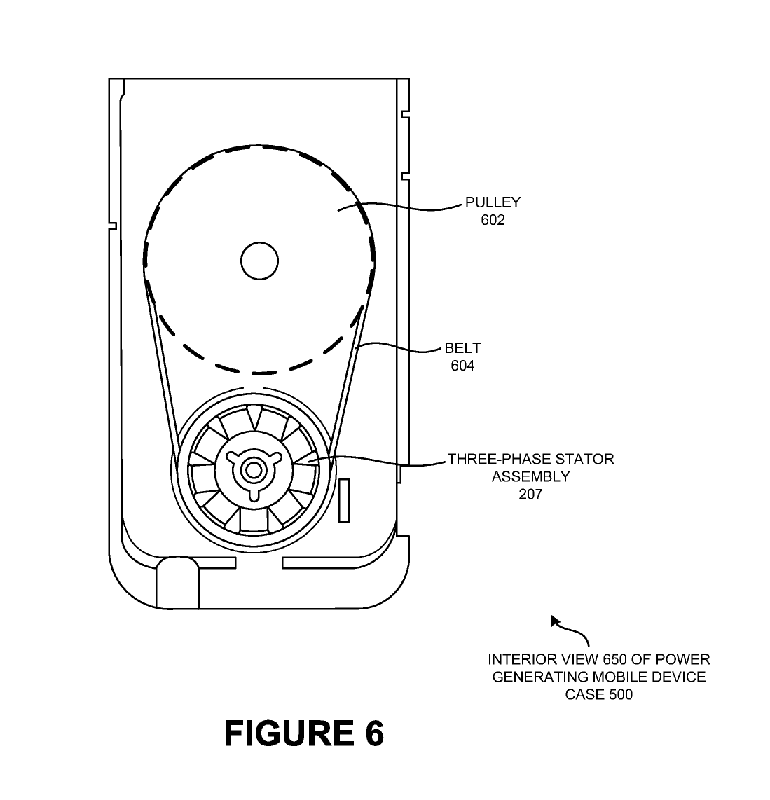

FIG. 6 is an interior view 650 of the power generating mobile device case 500 of FIG. 5 in a flat interior configuration, and in which the three-phase stator assembly 207 is mechanically coupled with the planetary gear train 200 (not shown) of FIG. 2 through a pulley 602 and a belt 604 to reduce a physical thickness required for the power generating mobile device case 500 and to increase efficiency of electricity generation when the handle 110 (not shown) is rotated, according to one embodiment. Specifically, FIG. 6 shows a pulley 602 and a belt 604.

The pulley 602 may be a wheel on an axle (e.g., the axle for sun gear 1008) and/or a shaft that is designed to support movement and/or change of direction of a cable and/or a belt (e.g., the belt 604) along its circumference. The pulley 602 may be used to lift loads, apply forces, and/or to transmit power. The belt 604 may be a loop of flexible material used to mechanically link two or more rotating shafts and/or machine parts, most often parallel. The belt 604 may be used as a source of motion, to transmit power efficiently, and/or to track relative movement. The belt 602 may be looped over the pulley 602 attached to the planetary gear train 200 (e.g., the pulley attached to the planetary module 1002) and the three phase stator 202.

In various embodiments, the belt 602 may have greater than or equal to 1/16 of an inch diameter. The belt 602 may be made of polyurethane, neoprene, and/or nitrile rubber (e.g., Buna-N). When the belt 602 is made of polyurethane, it may have 50/1000 of an inch diameter, according to one embodiment. In various embodiments, the belt 602 may be a drive belt and/or a timing belt. When the belt 602 is a timing belt, it may be a small pitch timing belt having a 1-2 millimeter pitch, according to one embodiment.

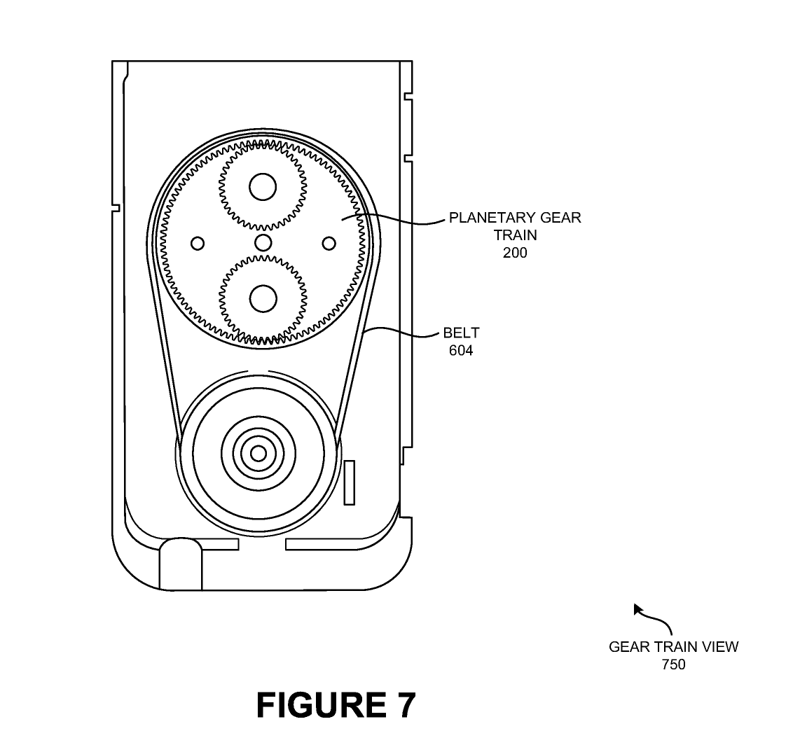

FIG. 7 is a gear train view 740 of the belt 604 of FIG. 6 coupled with the planetary gear train 200 of FIG. 2 through the pulley 602 (not shown) of FIG. 6, according to one embodiment. As shown in FIG. 6 and FIG. 7, the planetary gear train 200 may be attached to the pulley 602. The three-phase stator assembly 207 may be coupled to the planetary gear train 200 attached to the pulley 602 by the belt 604. According to various embodiments, turning the handle 110 causes the planetary gear train 200, which in turn rotates the pulley 602. This rotation drives the belt 604 which results in a spinning of the rotor can 204 around the three-phase stator 302, inducing an electric current 400 in the three-phase stator 302. Mechanically coupling the three-phase stator assembly 207 and the planetary gear train 200 using the pulley 602 and the belt 604 enables the planetary gear train 200 and the three-phase stator assembly 207 to be located on the same plane, which may reduce the physical thickness required for the power generating mobile device case 500 and/or may increase the efficiency of electricity generation when the handle 110 (not shown) is rotated.

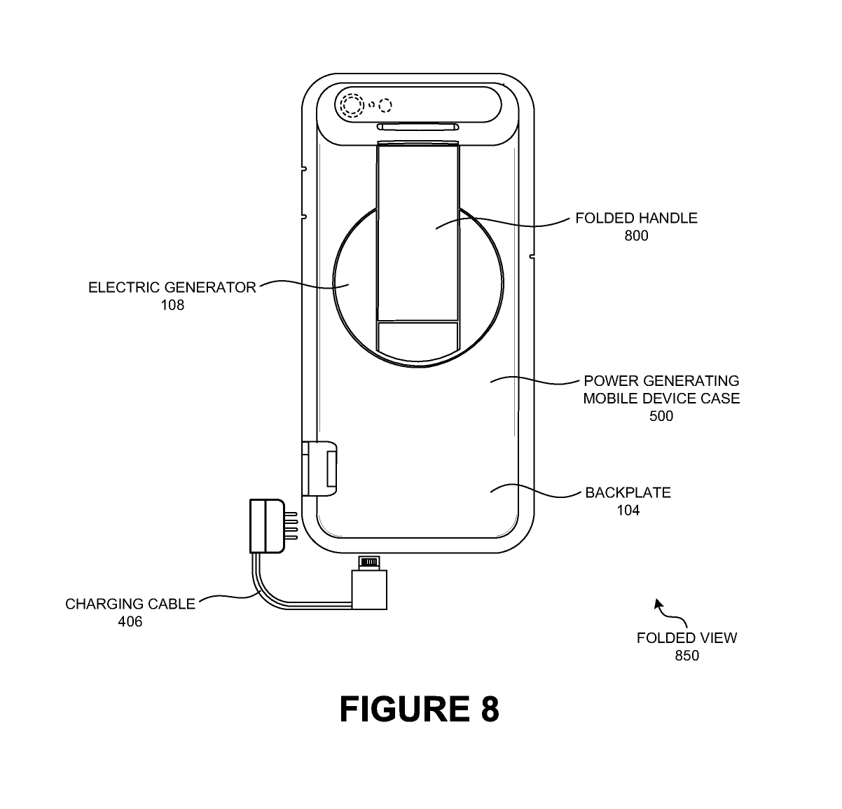

FIG. 8 is a folded view 850 of the power generating mobile device case 500 of FIG. 5, illustrating a folded state of a handle 800 (e.g., similar to the handle 110 of FIG. 1) to reduce thickness, according to one embodiment. Specifically, FIG. 8 shows a folded handle 800. The folded handle 800 may be similar to the handle 110 of FIG. 1. The folded handle 800 may be part of the casing 101 (e.g., part of the backplate 104) and may fit flush with the casing 101 (e.g., flush with the backplate 104) when not in use, according to one embodiment.

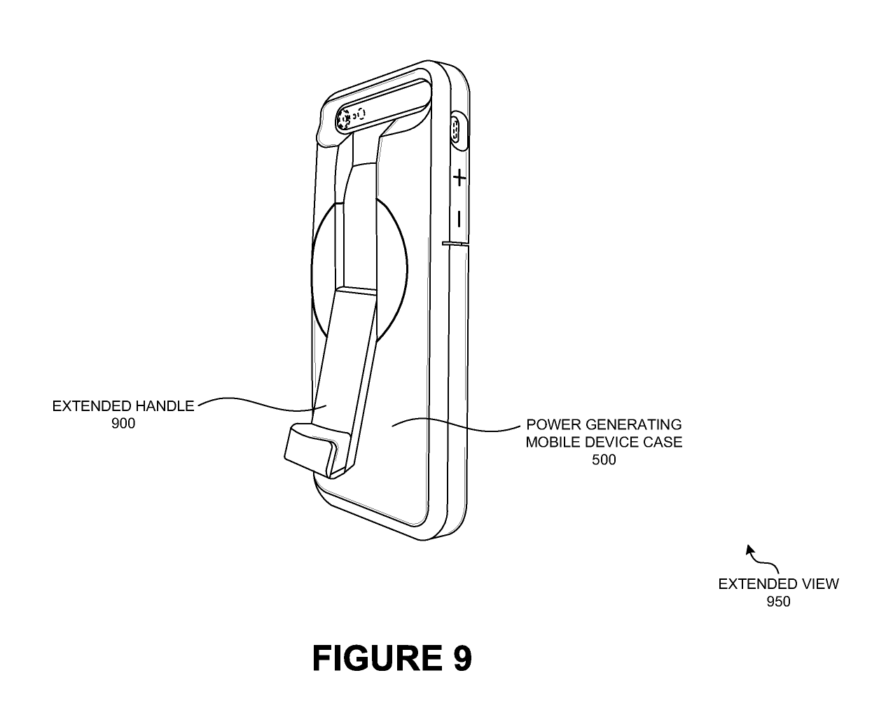

FIG. 9 is an extended view 950 of the power generating mobile device case 500 of FIG. 5, illustrating an extended state of a handle (e.g., similar to the handle 110 of FIG. 1) to provide electricity generation when the extended handle 900 is rotated, or, alternatively, to serve as a stand (e.g., similar to the stand 116 of FIG. 1) for the mobile device 106 of FIG. 1 when in extended form, according to one embodiment. Specifically, FIG. 9 shows an extended handle 900. The extended handle 900 may be similar to the handle 110 of FIG. 1. The extended handle 900 may be part of the casing 101 (e.g., part of the backplate 104) through which mechanical energy is delivered to the electric generator 108 (e.g., the extended handle 900 is turned, etc.) The end of the extended handle 900 may comprise a portion which may freely rotate, allowing a user to turn the extended handle 900 without having to readjust their grip to make a complete rotation. The extended handle 900 may be configured to act as a stand (e.g., the stand 116 of FIG. 1) in which the extended handle 900 is used to prop up the coupled and/or enclosed mobile device 106 at a desirable angle, when placed on a surface. In one embodiment, the extended handle 900 may be positioned and/or locked into one of multiple positions, providing multiple angles for different device orientations.

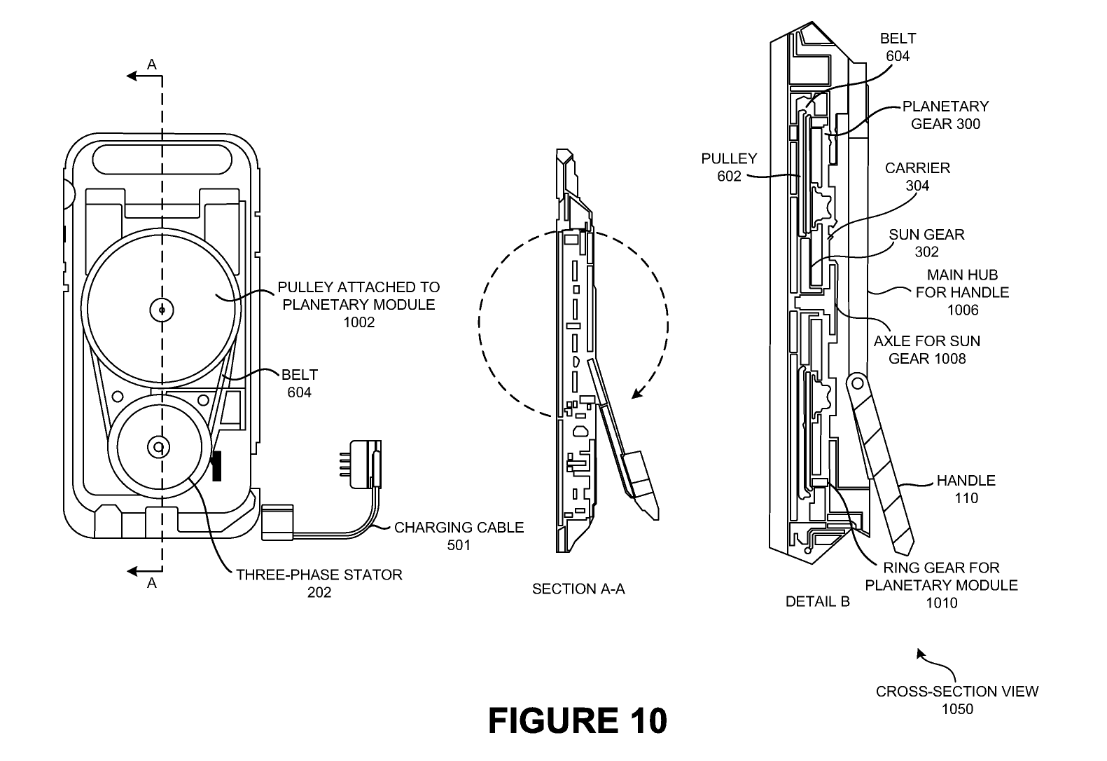

FIG. 10 is a cross-section (‘Section A-A’) view 1050 of the power generating mobile device case 500 of FIG. 5. Specifically, FIG. 10 shows a pulley attached to a planetary module 1002, a main hub for handle 1006, an axle for sun gear 1008, and a ring gear for planetary module 1010.

The pulley attached to a planetary module 1102 may be the pulley 602 attached to the planetary gear train 200 via the axle for the sun gear 1008. The main hub for the handle 1006 may connect the handle 110 to the electric generator 108 allowing the rotation of the handle 110 to be converted into a rotation of the electric generator 108. The axle for sun gear 1108 may be a central shaft for the rotating sun gear 302. The axle for sun gear 1108 may be fixed to the sun gear 302 rotating with the sun gear 302. The ring gear for planetary module 1010 may be a fixed, outer ring gear ring used in the planetary gear train 200. A planetary gear 300 may roll on the inside of the pitch circle of the ring gear for planetary module 1010. In various embodiments, one planetary gear 300 meshes with the sun gear 302, while a second planetary gear 300 meshes with the ring gear for planetary module 1010. When the carrier 304 is fixed, the ring gear for planetary module 1010 rotates in the same direction as the sun gear 302.

FIG. 10 further shows a power generating phone case wherein the components of the electric generator 108 are oriented on a single plane, rather than in a stacked configuration, according to various embodiments. Specifically, according to one embodiment, the planetary gear train 200 is coupled to the three-phase stator assembly 207 through the belt 602. This configuration may provide aesthetic benefits as well as efficiency benefits. Specifically, positioning the planetary gear train 200 on the same plane as the three-phase stator assembly 207 may result in a thinner profile of the power generating mobile device case 500. Therefore, the additional footprint added to the mobile device 106 when using the power generating mobile device case 500 may be minimized using the configuration shown in FIG. 10. This may appeal to a user of the power generating mobile device case 500 because it may be more comfortable for the user to hold the mobile device 106 coupled to and/or enclosed within the power generating mobile device case 500 and/or to store it in the user's pocket when it has a thinner profile.

Further, according to various embodiments, when using the belt 602 to couple the planetary gear train 200 to the three-phase stator 202, the planetary gear train 200 may provide a gear ratio of 15 to 1. This means that for every turn of the handle 110, the rotor can 204 spins 15 times resulting in greater efficiency gains per turn of the handle 110. Therefore, according to various embodiments, the user may be able to generate more power with fewer turns of the handle 110 and thereby expend less energy to charge the mobile device 106. This may be particularly beneficial when the user finds themselves in an emergency situation where they may have suffered an injury or have limited mobility or strength to power the mobile device 106 using the power generating mobile device case 500. Additionally, according to various embodiments, the electric generator 108 may be attached to the casing of the power generating mobile device case 500. According to various embodiments, the casing 101 may be capable of directly receiving the electric generator 108. For example, according to one embodiment, the backplate 104 may act as a receiver for the electric generator 108. According to another embodiment, there may be a separate receiver plate capable of receiving the electric generator 108. The separate receiver plate may also be capable of attaching to the casing 101 (e.g., by attaching to the backplate 104).

As a specific example, Peter is living in a city which has just experienced massive flooding. Power is out in large portions of the city, although cellular service has been partially restored. Peter needs to stay in contact with family, and have access to emergency services, but cannot charge his phone using a wall socket. Peter flips out the handle 110, ensures that the charging cable 406 is connected to the mobile device 106 and the power generating mobile device case 100. He begins to turn the handle 110 at a steady pace. Before long, Peter has restored enough charge in his phone to make a call or send a text message.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A power generating mobile device case, comprising:
a casing;
an electric generator, comprising:
a three-phase stator encompassed by a rotor can;
a planetary gear train; and
a handle;
wherein the three-phase stator is stationary,
wherein turning the handle causes the planetary gear train to spin the rotor can around the three-phase stator, inducing an electric current in the three-phase stator,
wherein the rotor can comprises at least one permanent magnet, and
wherein the power generating mobile device case is capable of coupling to a mobile device.

2. The power generating mobile device case of claim 1:
wherein the planetary gear train comprises:
a carrier;
at least one planetary gear; and
a sun gear,
wherein the carrier is affixed to the handle,
wherein the sun gear is affixed to the rotor can,
wherein the handle, the sun gear, and the carrier all rotate about a single axis,
wherein the at least one planetary gear is coupled to the carrier and is engaged with the sun gear, such that the carrier turns with the handle, causing the at least one planetary gear to orbit the sun gear, causing the sun gear and rotor can to spin, and
wherein the planetary gear train is encompassed by the three-phase stator and the rotor can.

3. The power generating mobile device case of claim 1, wherein the three-phase stator comprises at least one laminated core with at least 4 laminated layers.

4. The power generating mobile device case of claim 1 further comprising:
a charging cable;
a mobile device case connector on a first end of the charging cable;
a device connector on a second end of the charging cable; and
a charging port electrically coupled to the electric generator;
wherein the charging cable is capable of being at least one of attached, detached and reattached to the power generating mobile device case,
wherein at least one of the mobile device and another device is charged using the charging cable connected to at least one of the mobile device and the another device using the device connector and connected to the power generating mobile device case using the mobile device case connector.

5. The power generating mobile device case of claim 4, further comprising at least one battery, wherein the at least one battery is electrically coupled to at least one of the charging port and the electric generator.

6. The power generating mobile device case of claim 1, wherein the handle is configured to operate as a stand for the coupled mobile device.

7. The power generating mobile device case of claim 1 further comprising:
a pulley; and
a belt;
wherein the planetary gear train is attached to the pulley,
wherein the three-phase stator encompassed by the rotor can is coupled to the planetary gear train attached to the pulley by the belt, and
wherein the planetary gear train and the three-phase stator are located on the same plane.

8. The power generating mobile device of claim 7:
wherein the belt is at least one of a drive belt and a timing belt,
wherein the belt is made of at least one of polyurethane, neoprene and nitrile rubber, and
wherein the belt has at least 1/16 of an inch diameter.

9. The power generating mobile device case of claim 1, wherein the casing is comprised of one or more plates.

10. The power generating mobile device case of claim 1, wherein the casing is comprised of at least one of a faceplate and a backplate.

11. A power generating mobile device case, comprising:
a casing;
a synchronous electric generator, comprising:
a three-phase stator encompassed by a rotor can;
a planetary gear train;
a pulley;
a belt; and
a handle;
wherein the three-phase stator is stationary,
wherein the handle is capable of being stored flush with the casing when not in use,
wherein turning the handle causes the planetary gear train to spin the rotor can around the three-phase stator, inducing an electric current in the three-phase stator,
wherein the rotor can comprises an assembly of permanent magnets, and
wherein the power generating mobile device case is capable of coupling to a mobile device,
wherein the planetary gear train is attached to the pulley,
wherein the three-phase stator encompassed by the rotor can is coupled to the planetary gear train attached to the pulley by the belt, and
wherein the planetary gear train and the three-phase stator are located on the same plane.

12. The power generating mobile device case of claim 11:
wherein the planetary gear train comprises:
a carrier;
at least one planetary gear; and
a sun gear,
wherein the carrier is affixed to the handle,
wherein the at least one planetary gear is coupled to the carrier and is engaged with the sun gear, such that the carrier turns with the handle, causing the at least one planetary gear to orbit the sun gear, driving the belt causing the rotor can to spin.

13. The power generating mobile device case of claim 11:
wherein the casing further comprises:
a charging port electrically coupled to the synchronous electric generator; and
a charging cable storage chamber,
wherein at least one of the mobile device and another device is charged using a charging cable connected to the charging port while the synchronous electric generator is being operated.

14. The power generating mobile device case of claim 13, further comprising at least one battery, wherein the at least one battery is electrically coupled to at least one of the charging port and the synchronous electric generator.

15. The power generating mobile device case of claim 11, wherein the handle is configured to operate as a stand for the coupled mobile device.

16. The power generating mobile device case of claim 11, wherein the casing is comprised of one or more plates.

17. The power generating mobile device case of claim 11, wherein the casing is comprised of at least one of a faceplate and a backplate.

18. A power generating mobile device case, comprising:
a casing;
an electric multiphase generator, comprising:
a three-phase stator encompassed by a rotor can;
a planetary gear train; and
a handle;
wherein the three-phase stator is stationary,
wherein turning the handle causes the planetary gear train to spin the rotor can around the three-phase stator, inducing an electric current in the three-phase stator,
wherein the rotor can comprises at least one permanent magnet,
wherein the power generating mobile device case is capable of coupling to a mobile device,
wherein the planetary gear train comprises:
a carrier;
at least one planetary gear; and
a sun gear,
wherein the carrier is affixed to the handle, and
wherein the at least one planetary gear is coupled to the carrier and is engaged with the sun gear, such that the carrier turns with the handle, causing the at least one planetary gear to orbit the sun gear, causing the sun gear and the rotor can to spin.

19. The power generating mobile device case of claim 18:
wherein the casing further comprises:
a charging port electrically coupled to the electric multiphase generator; and
a charging cable storage chamber,
wherein at least one of the mobile device and another device may be charged using a charging cable connected to the charging port while the electric multiphase generator is being operated.

20. The power generating mobile device case of claim 18, wherein the handle is configured to operate as a stand for the coupled mobile device.
